(19) United States
(12) Patent Application Publication
(10) Pub. No.: US 2013/0249204 A1
(43) Pub. Date: Sep. 26, 2013

(54) Restraint Framework for Supporting a Passenger Restraint

(71) Applicants: Erin A. Fink, Salt Lake City, UT (US); Ryan Dark, Park City, UT (US)

(72) Inventors: Erin A. Fink, Salt Lake City, UT (US); Ryan Dark, Park City, UT (US)

(21) Appl. No.: 13/426,415

(22) Filed: Mar. 21, 2012

(51) Int. Cl. B60R 22/00

(52) U.S. Cl. 280/801.1

(57) ABSTRACT

A restraint framework for supporting a passenger restraint and for facilitating restraint of a passenger within a vehicle. The restraint framework comprises a lateral support and an upright support. The upright support has a restraint coupling location that facilitates coupling with a passenger restraint. The restraint framework further comprises vehicle couplers to facilitate securing the upright and lateral supports to the vehicle at vehicle attachment points. The restraint framework also comprises a junction to secure the lateral support to the vehicle about a lower vehicle attachment point, and to couple the lateral support to the upright support. The lateral support and/or the junction includes a restraint coupling location that facilitates coupling with the passenger restraint. Additionally, the restraint framework comprises an adjustment member operable with the upright and lateral supports to facilitate independent length adjustment, and to facilitate adjustment of the restraint coupling locations relative to the vehicle attachment points.

### BACKGROUND

A traditional child car seat includes a hard shell, plastic base (e.g., a hard shell bucket seat) that is attachable to a seat of a car. The plastic bucket seat is typically attached to the car seat using either the car's native seatbelts or, with increasing regularity, the known LATCH (Lower Anchors and Tethers for Children) system that secures to the vehicle at standardized anchor points (LATCH is a Federal standard required on most vehicles manufactured after Sep. 1, 2002). Once the plastic bucket seat is attached to the existing car seat, a child passenger can be secured to the plastic bucket seat using a restraint, such as a 5-point webbing harness type of restraint.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1A is a front view of a passenger restraint system in accordance with an exemplary embodiment of the present invention.

FIG. 1B is a rear view of the passenger restraint system of FIG. 1A.

FIGS. 2A-2E illustrate adjustments of a restraint framework in accordance with an exemplary embodiment of the present invention.

FIG. 3A is a front view of a restraint framework for supporting a passenger restraint in accordance with an exemplary embodiment of the present invention.

FIG. 3B is a rear view of the restraint framework of FIG. 3A.

FIG. 4A is a front view of a passenger restraint system in accordance with another exemplary embodiment of the present invention.

FIG. 4B is a restraint framework for supporting a passenger restraint in accordance with another exemplary embodiment of the present invention.

FIG. 5 is a junction of a restraint framework in accordance with an exemplary embodiment of the present invention.

FIG. 6A is a junction of a restraint framework in accordance with another exemplary embodiment of the present invention.

FIG. 6B is a junction of a restraint framework in accordance with still another exemplary embodiment of the present invention.

FIG. 7 is a junction of a restraint framework in accordance with yet another exemplary embodiment of the present invention.

FIG. 8 is a crotch strap and buckle configuration of a passenger restraint in accordance with an exemplary embodiment of the present invention.

FIG. 9 is a crotch strap and buckle configuration of a passenger restraint in accordance with another exemplary embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

Furthermore, various modifications and combinations can be derived from the present disclosure and illustrations, and as such, the following figures should not be considered limiting. It is noted that reference numerals in various figures will be shown in some cases that are not specifically discussed in that particular figure. Thus, discussion of any specific reference numeral in a given figure is applicable to the same reference numeral of related figures shown herein.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although traditional child restraint systems or car seats that incorporate a hard shell base, such as a plastic bucket or bucket-type seat, are generally effective in properly securing child passengers within a vehicle, there are a variety of difficulties and/or inefficiencies associated with these types of child restraint systems. For instance, the bulky, inflexible plastic bucket seat can limit or hinder use of the child car seat in some applications, such as accommodating larger children. Moreover, these tend to be cumbersome to install within or remove from a vehicle, particularly if frequently transferring from one vehicle to another vehicle. In addition, these can be difficult and expensive to transport, such as on an aircraft where the restraint system will later be used in a rental car.

Accordingly, a restraint framework is disclosed that can replace the bulky, inflexible hard shell base (e.g., plastic bucket seat) of traditional car seat designs. In one aspect, the restraint framework can be adjusted to fit a range of children sizes. In another aspect, the restraint framework can be easily compacted and stowed, such as for transport. In some exemplary embodiments, the restraint framework can include a lateral support and at least one upright support. The at least one upright support can have a restraint coupling location that facilitates coupling of at least part of a passenger restraint to the upright support. The restraint framework can also include a plurality of vehicle couplers operable to facilitate securing of the upright and lateral supports to the vehicle at a plurality of vehicle attachment points (e.g., the standard attachment points used in the LATCH system). The restraint framework can further include a junction operable with the lateral support to secure the lateral support to the vehicle about a lower vehicle attachment point, wherein at least one of the lateral support and the junction includes a restraint coupling location that facilitates coupling with at least part of the passenger restraint. Additionally, the restraint framework can include a plurality of adjustment members, at least one being operable with each of the upright and lateral supports to facilitate independent length adjustment of each of these, and to facilitate adjustment of the restraint coupling locations relative to the vehicle attachment points.

In addition, a passenger restraint system is disclosed. The restraint system can include the restraint framework that removably couples to a vehicle. The restraint framework can include at least one upright support, and a lateral support extending laterally relative to the upright supports. The upright and lateral supports can be length adjustable to position restraint coupling locations about the upright and lateral supports that are adjustable relative to vehicle attachment points of the framework. The restraint system can also include a passenger restraint coupled or otherwise secured to the restraint framework at the passenger restraint coupling locations. The passenger restraint can be configured to releasably restrain an individual about the restraint framework and the vehicle. Like the restraint framework, the passenger restraint can be adjusted, and easily compacted and stowed (e.g., with or as coupled to the restraint framework).

A method for facilitating the restraint of an individual within a vehicle using a vehicle restraint system is also disclosed. The method can comprise providing a restraint framework having a plurality of supports, at least some of the supports comprising a restraint coupling location. The method can also comprise facilitating the releasable coupling of the supports to the vehicle. Additionally, the method can comprise facilitating the coupling of a passenger restraint to the restraint framework about the restraint coupling locations, the passenger restraint being configured to releasably restrain an individual about the restraint framework and the vehicle.

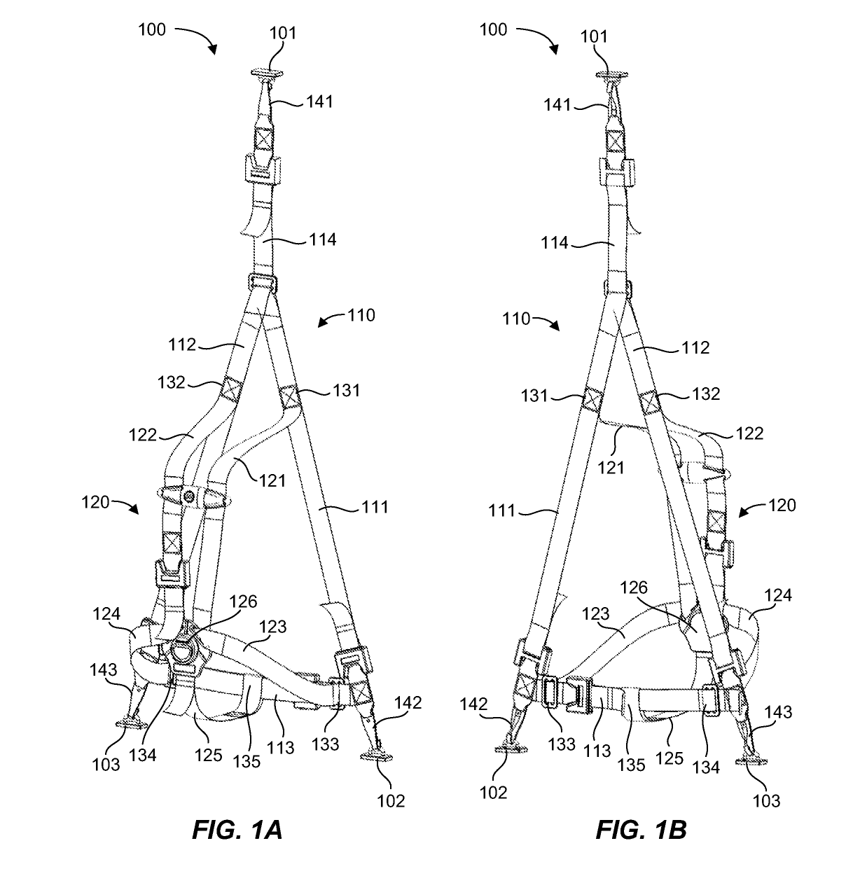

One exemplary embodiment of a passenger restraint system 100 is illustrated in FIGS. 1A and 1B. The passenger restraint system 100 can comprise a restraint framework 110 and a passenger restraint 120 coupled or otherwise secured to the restraint framework 110. The passenger restraint 120 can be configured to releasably restrain an individual about the restraint framework 110 and a vehicle, particularly an existing passenger seat of a vehicle. The restraint framework 110 is intended to replace, in some embodiments, the hard shell, plastic bucket seat of a traditional car seat design. The restraint framework 110 can couple to the vehicle, and can function as a support system for the passenger restraint. The restraint framework 110 can couple to the vehicle directly about an existing passenger seat such that the restraint framework 110 can be secured against the passenger seat. In this way, the passenger restraint system 100 can make use of a vehicle's existing seating surfaces to seat the passenger without requiring the use of a hard shell or other type of base. Securing a child about the existing seats of a vehicle is likely to be more convenient to users, and is also more likely to increase comfort for most child passengers as they are able to be seated directly on the existing passenger seat of the vehicle without having to be confined to a rigid seat, although other seating scenarios are contemplated herein (e.g., the passenger restraint system 100 being used in conjunction with a booster or other type of seat elevating the passenger off of the seat). Indeed, a passenger can be secured about the restraint framework (and the vehicle, or the seat of the vehicle) via the passenger restraint 120.

The various components or elements of the restraint framework 110 and/or the passenger restraint 120 can be configured to be flexible. For example, the various upright and lateral supports of the restraint framework 110 discussed herein can be formed from materials similar to vehicle seat belts or other flexible passenger restraints, such as nylon webbing. Utilizing such materials, the restraint framework 110, as well as the passenger restraint 120, can more easily accommodate different sized passengers. Moreover, by utilizing a flexible configuration the restraint framework 110 (and/or the passenger restraint 120) can be rolled, folded, or otherwise compacted to a compact storage configuration for easy stowage and transport of the passenger restraint system 100.

In one aspect, the restraint framework 110 can removably couple to the vehicle at attachment points 101, 102, 103, which attachment points are illustrated as comprising anchors or anchor loops (e.g., anchors secured within a vehicle that can receive a LATCH or other type of restraint-type coupling). The attachment points can be located at any suitable location on a vehicle, but are typically located in standard locations. In general, such attachment points can be associated with a vehicle seat, with upper attachment point 101 being located on a ceiling above the seat or on a support surface behind the seat, such as a back of the seat or a rear deck. Lower attachment points 102, 103 can be located near a base of the seat proximate to an intersection between the bottom and back cushions of the seat. The attachment points can comply, for example, with the LATCH system, which eliminates the need for a vehicle's seat belts in child safety seat installation by specifying anchor attachment points associated with the vehicle's seats. Thus, in one aspect, the restraint framework 110 is coupled exclusively to vehicle anchor attachment points and does not wrap entirely around the seat or utilize an existing vehicle seat belt in order to couple with the vehicle. The compact and low-profile nature of the passenger restraint system 100 can allow installation of as many passenger restraint systems 100 in a vehicle seat as there are native seat belts, particularly when using the LATCH system. For example, on a rear bench seat equipped with the LATCH system and having three native seat belts, three restraint systems 100 may be installed in a side-by-side relationship, thus permitting three children to be safely restrained within the vehicle similar to three adults using the native seat belts. This is advantageous in that most vehicles comprise rear seats with three seat belts. However, many of these are more compact vehicles that will only accommodate two conventional child car seats having the rigid, hard shell bucket-type bases discussed herein due to the bulky space occupying nature of such bases.

The restraint framework 110 can comprise upright supports 111, 112 and a lateral support 113 extending laterally relative to the upright supports. In one embodiment, the upright supports 111, 112 and the lateral support 113 can each be length adjustable. In another embodiment, one or more can be adjustable. By adjusting the length of the upright and lateral supports, restraint coupling locations 131, 132, 133, 134, 135 can be positioned and repositioned relative to the vehicle attachment points 101, 102, 103. This adjustability in positioning the restraint coupling locations relative to the vehicle coupling locations 101, 102 and 103 can be used to properly locate shoulder straps 121, 122, for example, of the passenger restraint 120 for a passenger to be secured by the passenger restraint system 100. Indeed, the shoulder strap 121 of the passenger restraint 120 is coupled to the restraint framework 110 at the restraint coupling location 131. The shoulder strap 122 is coupled to the restraint framework 110 at the restraint coupling location 132. The lateral support 113 is coupled to the restraint framework 110 on one end at the restraint coupling location 133, and on the other end at restraint coupling location 134. As such, adjustment of one or more of the restraint coupling locations causes the passenger restraint 120 to be likewise adjusted to obtain an optimal fit in terms of safety and comfort for a particular child.

In one aspect, the upright and lateral supports 111, 112, 113 can at least partially define a restraint coupling profile. The restraint coupling profile can be further defined, at least in part, by the restraint coupling locations 131, 132, 133, 134, 135. The restraint coupling profile can be adjustable relative to the vehicle attachment points 101, 102, 103 to position the restraint coupling locations 131, 132, 133, 134, 135 for a passenger.

As shown in the figures, the exemplary passenger restraint 120 comprises a five point harness, having two shoulder straps 121, 122, two waist straps 123, 124, and a crotch strap 125. The five point harness shown includes a three point buckle 126 to couple the various straps of the restraint. In this case, shoulder strap 121 and waist strap 123 are coupled to one point of the buckle 126, shoulder strap 122 and waist strap 124 are coupled to another point of the buckle 126 and crotch strap 125 is coupled to the other point of the buckle 126. It should be recognized, however, that any suitable passenger restraint and buckle arrangement, such as a three point, four point, or seven point harness, may be used with the restraint framework 110. In one aspect, the restraint 120 can be permanently coupled to the restraint framework 110, such as with sewn joints, rivets, welds, etc. In another aspect, the restraint 120 can be removably coupled to the restraint framework 110, such as with a clip, hook, strap, band, clasp, loop, ring, plate, etc.

The straps of the passenger restraint 120 can also be length adjustable to obtain a proper and safe fit, and to properly secure the passenger about the restraint framework and the vehicle. Thus, in one aspect, the passenger restraint 120 can be adjusted to fit the passenger independent of any adjustment of the restraint framework 110, such as the upright and lateral supports 111, 112, 113. In other words, length adjustment in either one or both of the restraint framework and the passenger restraint is contemplated depending upon the particular exemplary embodiment. For example, in some embodiments a length adjustment of the upper and lower supports 111, 112, 113 of the framework 110 does not alter the lengths of the straps in the passenger restraint 120. In use, therefore, the restraint framework 110 can be initially adjusted to fit a particular seat in a vehicle as well as adjusted to position any of the restraint coupling locations 131, 132, 133, 134, 135 to fit a particular passenger. Once this initial adjustment has been made, the passenger can be secured within the restraint system via the passenger restraint 120 about the restraint framework 110, with the restraint framework 110 being positioned or located behind the passenger and against the seat. In other words, the passenger is secured by the passenger restraint 120, which is coupled to the framework 110 that supports the passenger restraint 120 and is coupled to the vehicle. The passenger is therefore not secured by the framework 110, but is instead secured about the restraint framework 110 by the passenger restraint 120. Thus, in one aspect, it can be said that the restraint framework 110 forms no part of the passenger restraint 120 because the restraint framework 110 supports the passenger restraint 120 and does not itself directly secure the passenger (e.g., extend around any part of the body of the passenger).

Additionally, because the restraint framework 110 supports the passenger restraint 120, the passenger restraint system 100 can be used independent of the vehicle's native safety belt. Furthermore, because the passenger restraint 120 is configured to secure the passenger, the upright and lateral supports 111, 112, 113 of the restraint framework 110 do not separate or come apart in order to secure the passenger. Rather, these can be left in a secured, installed state (i.e., tightly secured against the seat of the vehicle) with the passenger restraint 120 being manipulated (e.g., separated or unbuckled, etc.) to safely restrain the passenger within the vehicle. Moreover, because the lengths of the restraint straps 121, 122, 123, 124, 125 and the framework supports 111, 112, 113 are independently adjustable, there is no inverse relationship between lengths of the restraint straps and the framework supports. In other words, lengthening a restraint strap does not shorten a framework support, and vice versa.

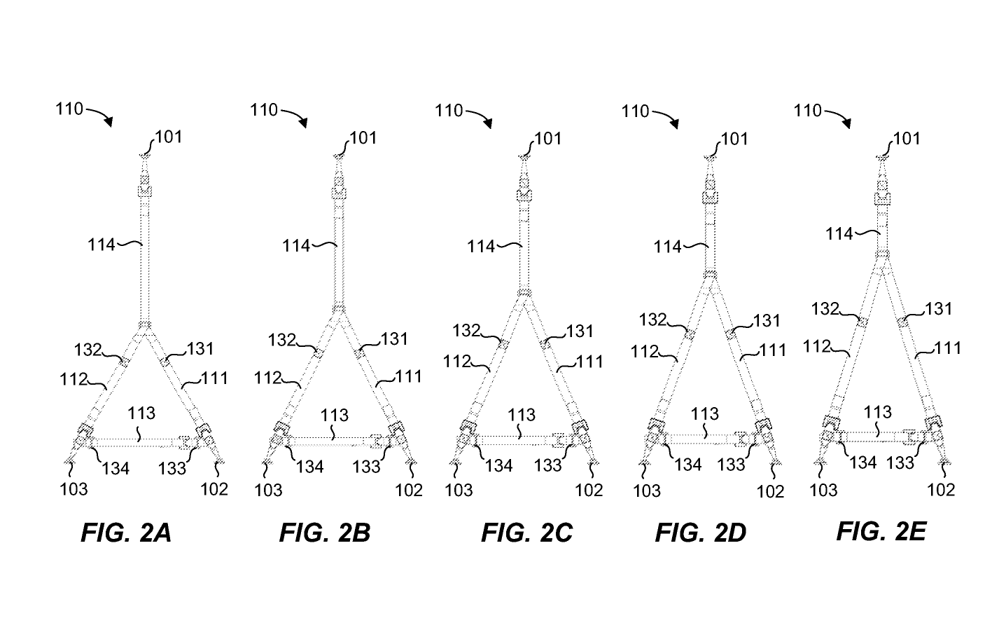

Because different passengers can differ in size and also because attachment locations can differ between car seats, the framework supports 111, 112, 113 can be adjustable to accommodate not only a certain passenger, but also a certain seat in a vehicle. For example, as illustrated in FIGS. 2A-2E and with continued reference to FIGS. 1A and 1B, the upright supports 111, 112 of the restraint framework 110 can be adjusted to position restraint coupling locations 131, 132 to suit a particular passenger to be secured by the shoulder straps 121, 122 of the passenger restraint 120 that couple to the restraint framework 110 about the respective coupling locations 131 and 132 of the upright supports. Likewise, the lateral support 113 can be adjusted to suit the passenger and/or the seating location and associated lower attachment points 102, 103. In one aspect, adjustment of the lateral support 113 can adjust the positions of the restraint coupling locations 133, 134. The restraint system may further comprise an upper extension member 114 that can also be length adjustable to accommodate the seating location and an associated upper attachment point 101 of the vehicle.

When installed, the upright and lateral supports 111, 112, 113 of the framework 110 can be tensioned sufficient to prevent excessive movement away from the seat while restraining a passenger in an accident. With sufficient tension in the framework supports 111, 112, 113, the passenger can be adequately restrained and supported during erratic driving or an accident despite the use of flexible materials in the construction of the framework 110. Even with proper tensioning in the framework 110, the flexibility of the framework 110 can allow the restraint coupling locations to move in various directions (e.g., away from the seat, laterally relative to the seat, or a combination of these) to a certain degree under a load. This can be beneficial when securing a passenger because the flexibility in the framework 110 can make it easier to manipulate the restraint 120 around the passenger. The flexibility of the framework 110 can also dissipate energy to a certain extent in an accident as the framework 110 pulls tight under loads induced by the passenger during the accident.

In addition, the restraint framework 110 can include vehicle couplers 141, 142, 143 operable to facilitate coupling of the restraint framework 110 to the vehicle at the vehicle attachment points 101, 102, 103. For example, the restraint framework 110 can comprise vehicle couplers similar to those found for use with the LATCH system. Vehicle couplers 141, 142, 143 can comprise a clip, hook, strap, band, clasp, loop, ring, plate, or any other suitable structure for coupling the restraint framework 110 to a vehicle. Although the restraint framework 110 is shown as being coupled to the vehicle at three attachment points 101, 102, 103, it should be recognized that the restraint framework 110 can be coupled to the vehicle at any suitable number of attachment points and at any suitable location.

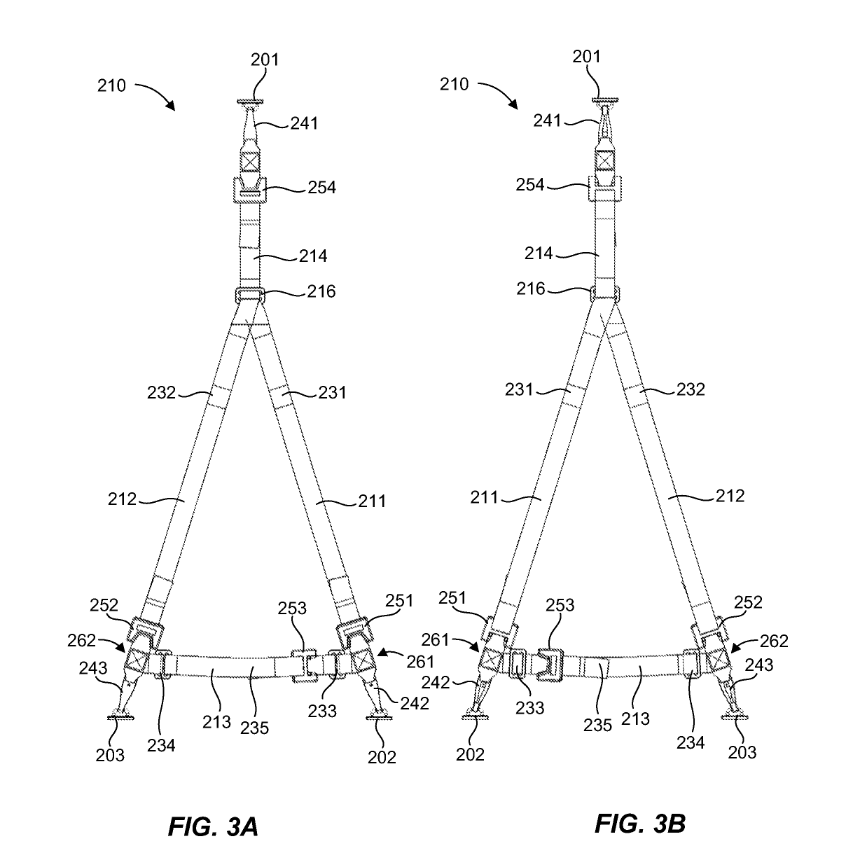

One embodiment of a restraint framework 210 for supporting a passenger restraint and for facilitating restraint of a passenger within a vehicle is illustrated in FIGS. 3A and 3B. The restraint framework 210 can comprise upright supports 211, 212, which can have restraint coupling locations 231, 232 that provide the locations for and that facilitate coupling of a passenger restraint (not shown, but see FIGS. 1A-1B) to the upright supports 211, 212. With passenger restraint coupling locations 231, 232, the restraint framework 210 can facilitate the releasable restraint of an individual about the upright supports 211, 212 and the lateral support 213, as well as the vehicle. In one aspect, no part of the framework 210 is used to directly releasably restrain an individual. In other words, the framework 210 does not extend about or around the body of the passenger, but functions as the support or base for a passenger restraint. This allows all of the support members (e.g., the lateral and the upright supports) of the framework 210 to be secured firmly about the seat. In a specific aspect, each of the upright supports 211, 212 and the lateral support 213 comprises an inseparable structural member. In other words, the structure of the upright and lateral supports is not configured to separate, for example, to allow a passenger to gain access to a rear of the framework 210 in order to be secured by the framework itself against a vehicle seat. A passenger restraint coupled to the framework 210 can be used to secure the passenger and can include separable buckles to allow the passenger to be properly positioned within and then secured by the passenger restraint about or to the framework and the vehicle.

The restraint framework 210 can also include a lateral support 213 and a junction, such as junctions 261, 262, operable with the lateral support 213 to secure the lateral support 213 to the vehicle about a lower vehicle attachment point, such as attachment points 202, 203. Similarly, the junctions 261 and 262 can also be operable with the upright supports 211 and 212, respectively, to secure the upright supports to the vehicle. Each of the upright and lateral supports 211, 212, 213 can comprise ends that terminate at a junction and that are fixed at the junction. Thus, the length of each support can be adjusted independent of the other supports. In one aspect, the junctions 261, 262 can be operable with the upright supports 211, 212, respectively, to secure the upright supports to the vehicle about the lower vehicle attachment points 202, 203, respectively.

On one side of the restraint framework 210, restraint coupling location 233 can be formed or placed about either the lateral support 213 or joint 261 to facilitate coupling with the passenger restraint. On the other side of the restraint framework 210, restraint coupling location 234 can be formed or placed about either the lateral support 213 or joint 262 to facilitate coupling with the passenger restraint. The restraint framework 210 can also include vehicle couplers 241, 242, 243 operable to facilitate securing of the upright supports 211, 212 and the lateral support 213 to the vehicle at vehicle attachment points 201, 202, 203, respectively.

In one aspect, the upright supports 211, 212 converge to a common location, and are operable with the upper vehicle coupler 241. The common location can be defined by a buckle 216 to provide a coupling or gathering location for the upright supports 211, 212. In addition, the restraint framework 210 can include an upper extension 214 operable with the upright supports 211, 212 to secure the upright supports to the vehicle about an upper vehicle attachment point 201. In one exemplary embodiment, the upper extension 214 and the upright supports 211, 212 comprise separate structural members. In this case, the upright supports 211, 212 can terminate at the buckle 216, with the upper extension 214 extending from the buckle 216 toward the upper vehicle coupler 241. In another exemplary embodiment, the upper extension 214 comprises at least a portion of the upright supports 211, 212 coming together and overlapping one another through and beyond the buckle 216. In this case, the upright supports 211, 212 can be gathered by the buckle 216 and extend from the buckle toward the upper vehicle coupler 241.

Additionally, the restraint framework 210 can include adjustment members 251, 252, 253 to facilitate adjustment of the restraint coupling locations 231, 232, 233, 234, 235 relative to vehicle attachment points 201, 202, 203. An adjustment member can include a buckle, cam buckle, or any other form of length adjustment mechanism or structure suitable for use with the restraint framework 210. In one aspect, at least one adjustment member can be operable with each of the upright and lateral supports 211, 212, 213 to facilitate independent length adjustment of the supports.

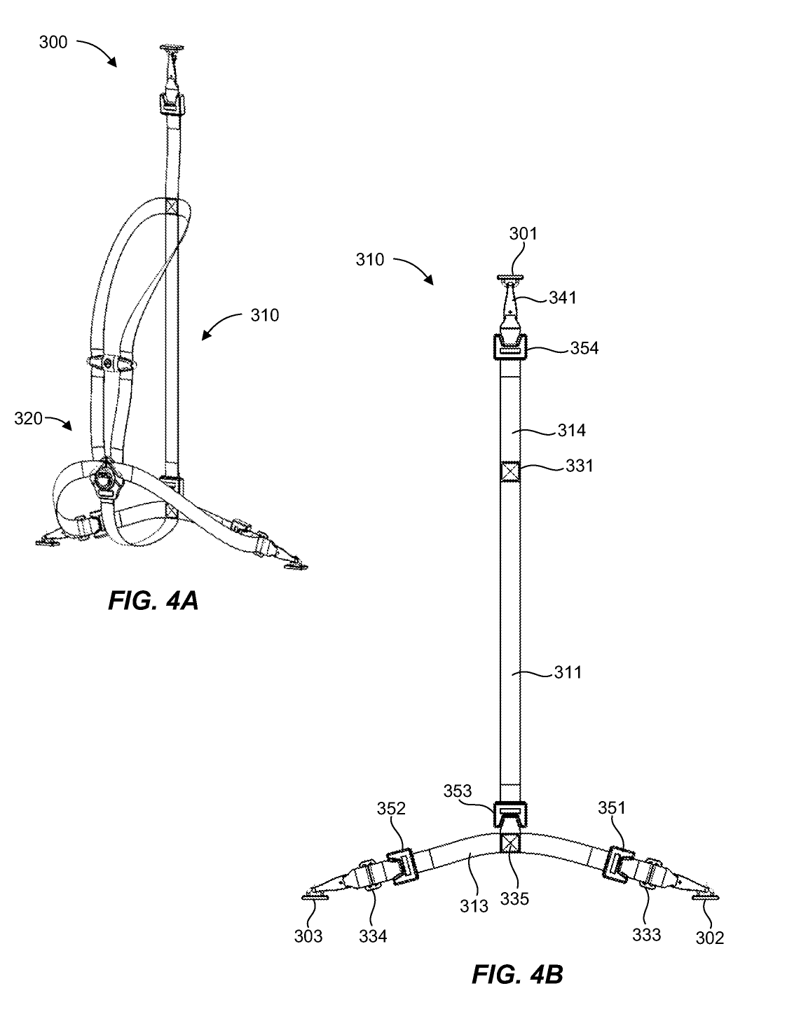

Another embodiment of a passenger restraint system 300, a restraint framework 310, and a restraint 320 is illustrated in FIGS. 4A and 4B. This example illustrates the restraint framework 310 having only a single upright support 311. Aside from this distinction, the restraint framework 310 is similar in many respects to the restraint framework 110, 210 of FIGS. 1A and 1B, and FIGS. 3A and 3B, respectively. The upright support 311 can be coupled to a lateral support 313. Adjustment members 351, 352, 353, 354 can facilitate adjustment of restraint coupling locations 331, 333, 334, 335 relative to vehicle attachment points 301, 302, 303. In addition, the restraint framework 310 can include an upper extension 314 operable with the upright support 311 to secure the upright support to the vehicle about the upper vehicle attachment point 301. In one embodiment, the upper extension 314 and the upright support 311 can comprise separate structural members. In this case, the upright support 311 can terminate at restraint coupling location 331, with the upper extension 314 extending from restraint coupling location 331 toward an upper vehicle coupler 341. In another embodiment, the upper extension 314 can comprise at least a portion of the upright support 311. In this case, the upright support 311 and the upper extension can be part of the same structural member with no need for a buckle between the upright support 311 and the upper extension 314.

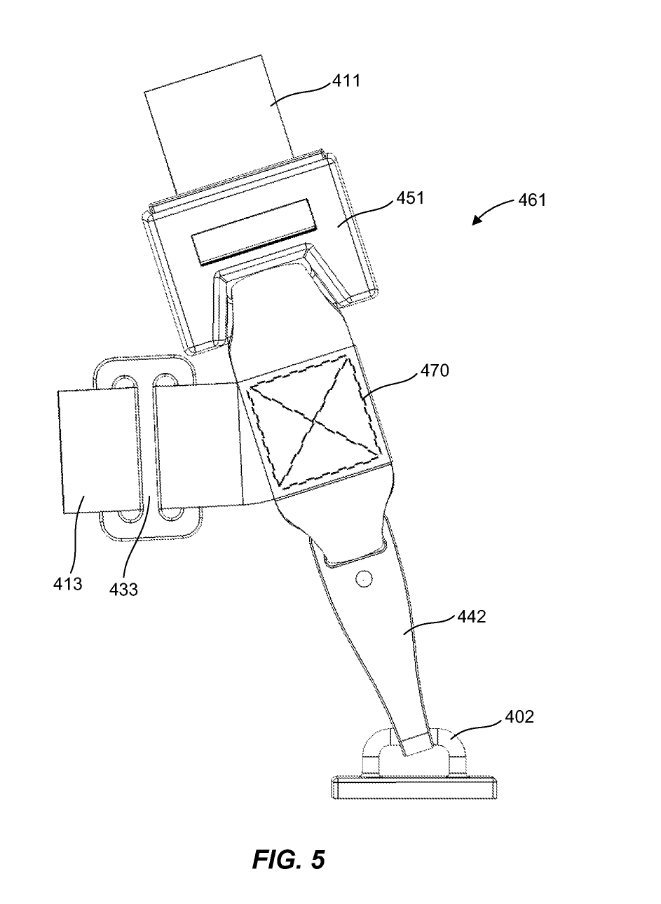

Referring to FIG. 5, illustrated is an exemplary embodiment of a junction 461 of a restraint framework as disclosed herein. The junction 461 can be operable with a lateral support 413 to secure the lateral support to a vehicle about a lower vehicle attachment point 402. For example, the junction 461 can couple the lateral support 413 to a lower coupler 442, which can be secured to the lower vehicle attachment point 402. The lateral support 413 can be coupled to the junction via a sewn joint 470. The lateral support 413 can include a restraint coupling location 433 for coupling with a passenger restraint. The restraint coupling location can be fixed or movable relative to the lateral support 413. Additionally, the junction 461 can be operable and couple with an upright support 411 to secure the upright support to the vehicle about the lower vehicle attachment point 402. For example, the upright support 411 can be coupled to the junction 461 via a length adjustment member 451, which is itself secured to the material extending from the sewn joint.

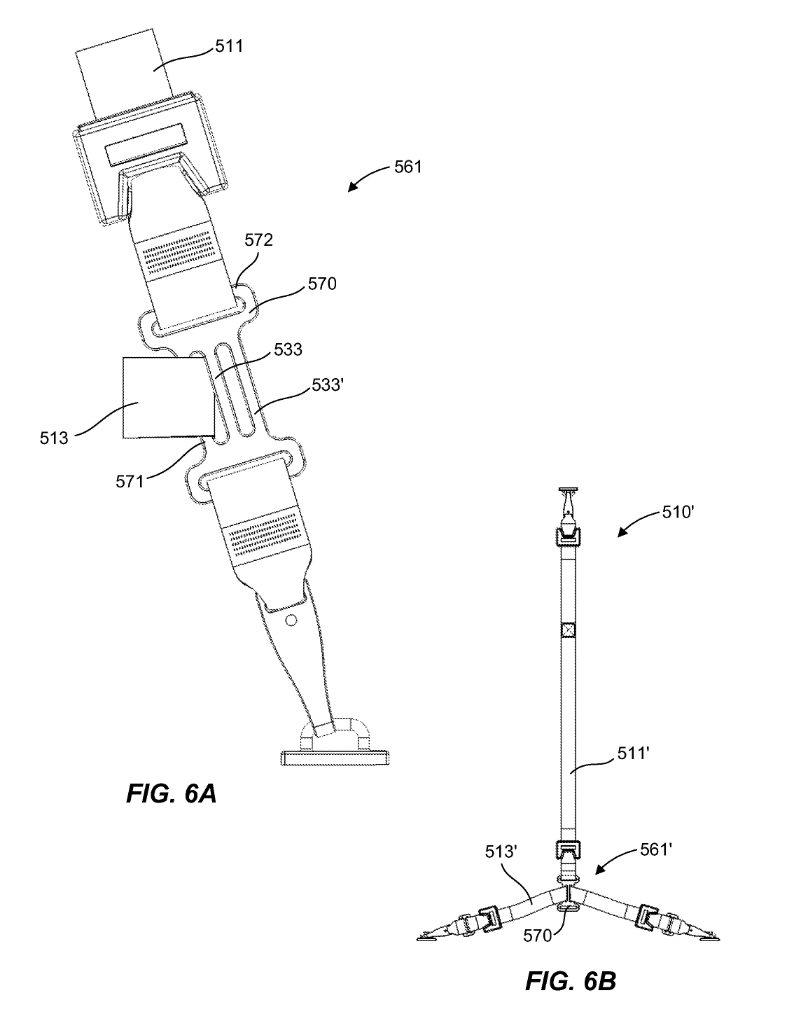

Referring to FIG. 6A, illustrated is another exemplary embodiment of a junction 561 of a restraint framework as disclosed herein. Instead of a sewn joint, as disclosed in FIG. 5, the junction 561 can comprise a plate 570 having a lateral support coupling feature 571 coupled to a lateral support 513, an upright support coupling feature 572 coupled to an upright support 511, and a restraint coupling location feature 533 for coupling with a passenger restraint (not shown). The lateral support coupling feature 571 and the restraint coupling feature 533 can be configured to be in line with the upright support 511 (or have an axis parallel to an axis of the upright support 511). The upright support coupling feature 572 can be configured to be substantially orthogonal to the lateral support and restraint coupling features 571 and 533, and the upright support 511. Alternatively, the plate 570 can comprise an additional restraint coupling location feature 533′ can be used for coupling with a passenger restraint or other item that may be coupled to or associated with a passenger restraint system. As will be recognized by those skilled in the art, restraint coupling location feature 533′ can be omitted from the plate 570 in some embodiments if it is deemed an extraneous feature. The plate 570 can be constructed of a metal, plastic, composite, or any other suitable material capable of supporting a load, and particularly those anticipated to exist within the restraint systems described herein.

FIG. 5B illustrates is an embodiment of a plate 570 utilized in another junction 561′ of a restraint framework 510′ as disclosed herein. For example, the restraint framework 510′ can be configured similar to the restraint framework 310 of FIG. 4B and the plate 570 can replace or substitute for a sewn junction between upright support 511′ and lateral support 513′.

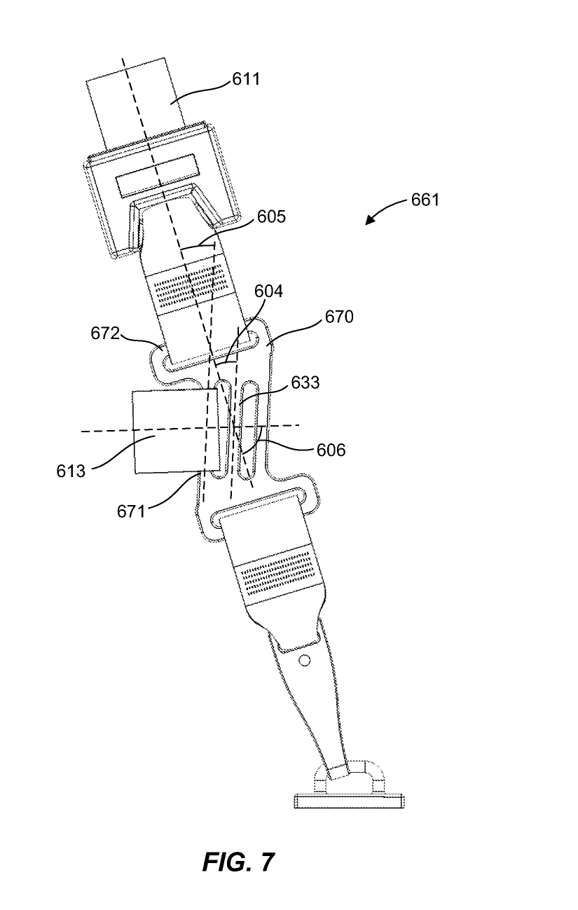

Referring to FIG. 7, illustrated is another embodiment of a junction 661 of a restraint framework as disclosed herein. Junction 661 is similar to junction 561 of FIG. 6A in many respects, as junction 661 includes a plate 670 having a lateral support coupling feature 671 coupled to a lateral support 613, an upright support coupling feature 672 coupled to an upright support 611, and a restraint coupling location feature 633 for coupling with a passenger restraint. In junction 661, however, at least one of the lateral support coupling feature 671 and the restraint coupling location feature 633 of the plate 670 are configured at an angle 604, 605, respectively, relative to the upright support 611. The angles 604, 605 can better accommodate an angle 606 formed between the upper support 611 and the lateral support 613 compared to the junction 561 of FIG. 6A. Since the angle 606 formed between the upper support 611 and the lateral support 613 can vary due to a length adjustment of the upper and/or lateral supports, the angles 604, 605 can be selected to optimally accommodate the upright and lateral supports representative of a midpoint in the likely adjustment range. For example, angles 604, 605 can be greater than about 0 degrees and up to about 45 degrees, as measured from the longitudinal axis of the upper support 611. It is noted that an angle of 0 degrees is found in junction 561 of FIG. 6A. It should also be recognized that the angles 604, 605 can, but need not, be equal to one another. For example, angle 605 can be selected to accommodate a coupling with a passenger restraint and need not be influenced by angle 604, which can be related to the angle 606 between the upright support 611 and the lateral support 613. In one aspect, angle 604 and/or angle 605 can be complementary to the angle 606. For example, angle 605 and angle 606 can sum to equal 90 degrees.

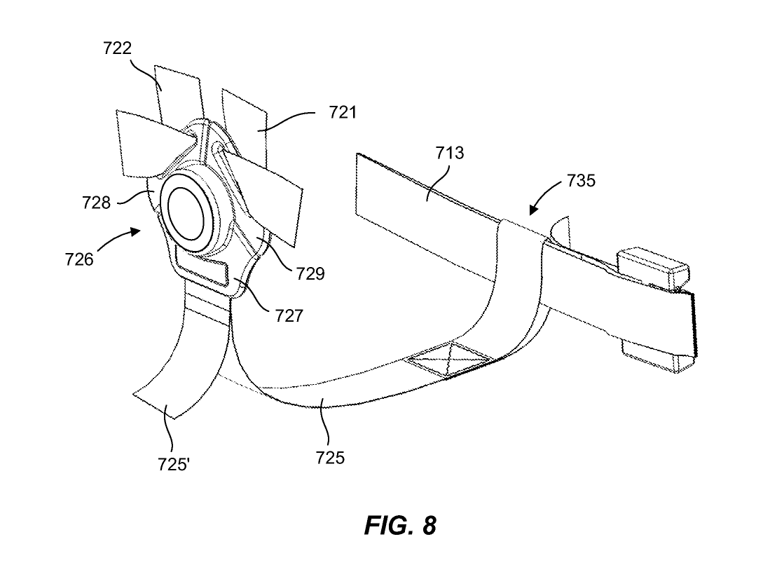

Referring to FIG. 8, illustrated is an example configuration of a portion of a passenger restraint, particularly a passenger restraint buckle 726 and a restraint strap 725. In the example shown, the restraint strap 725 is a crotch strap that can couple or otherwise be secured to a lateral support 713 at restraint coupling location 735. The restraining location 735 is moveable or adjustable along the length of the lateral support 713. As specifically shown, the restraint or crotch strap wraps around the lateral support 713, forming a loop through which the lateral support passes. The restraint or crotch strap may be moveable in a bi-directional manner about the lateral support 713. Moreover, the restraint strap can be configured to be releasably coupled to the lateral support 713.

The buckle 726 can be a three point buckle for a five point harness restraint. The three point buckle 726 includes a base portion 727 and attachment portions 728, 729 that are each individually releasably attachable to the base portion 727, and that are operable to secure shoulder straps 722 and 721, respectively. Indeed, the attachment portions 728 and 729, which are each operable with shoulder straps of a passenger restraint, can be caused to engage the base portion 727, and then selectively released upon activation of the buckle (e.g., by pushing the release button), thereby facilitating easy securing and release of the passenger within the passenger restraint. The base portion 727 can include a length adjustment feature, such as an integrated length adjustment feature (e.g., a cam mechanism), to facilitate length adjustment of the crotch strap 725. An integrated length adjustment feature (or other type of adjustment feature) operable with the buckle 726 can maintain ready access to a free end 725′ of the crotch strap 725 to simplify securing a passenger with the passenger restraint, and adjusting the crotch strap 725. Those skilled in the art will recognize that the buckle of a passenger restraint can include an integrated length adjustment feature for any associated strap of the restraint. Moreover, it is contemplated herein that the passenger restraint can be any type of a restraint, and is not limited to a five point passenger restraint.

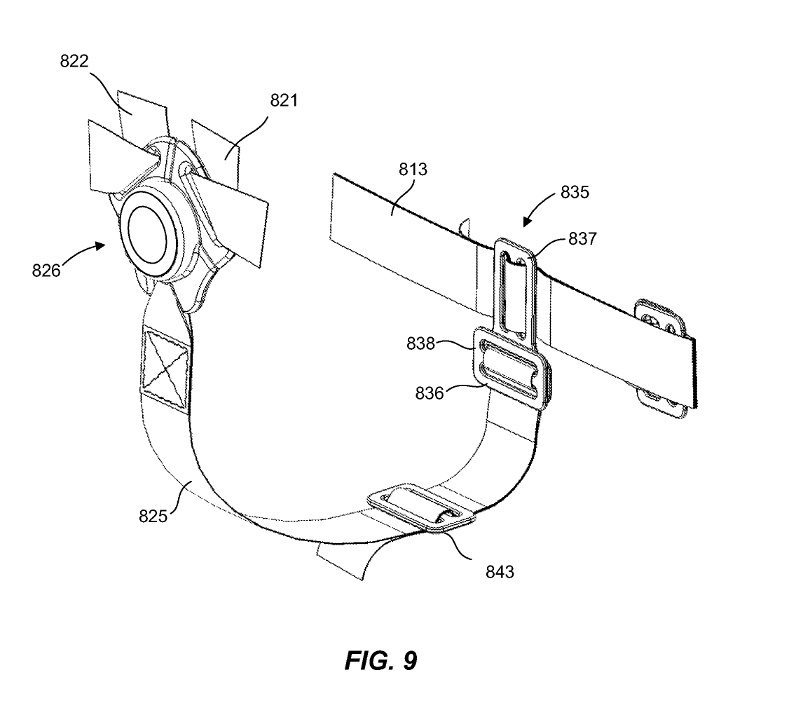

Referring to FIG. 9, illustrated is another example configuration of a passenger restraint buckle 826 and a restraint strap 825 as part of a passenger restraint. In some embodiments of a passenger restraint, a buckle 826 without an integrated length adjustment feature may be included. In such embodiments, a T-buckle 836 can be used to couple a crotch strap 825 of the restraint to a middle portion of a lateral support 813 of a restraint framework at a restraint coupling location 835. The restraining location 835 is moveable or adjustable in a bi-directional manner along the length of the lateral support 813. In addition, the buckle 826 can be made to be operable with and to secure or couple to the crotch or restraint strap 825, as well as shoulder straps 821 and 822 in a similar manner as discussed above.

The T-buckle 836 can be configured in a T shape and can comprise a base portion 837 slidably coupled to the lateral support 813 and a cross portion 838 coupled to the crotch strap 825. In one aspect, the base portion 838 and/or the cross portion 838 can include a length adjustment feature, such as a cam mechanism, to adjust a length of the lateral support 813 or the crotch strap 825, respectively. In the embodiment shown, length adjustment of the crotch strap 825 is made possible via a buckle 843 through which the crotch strap 825 extends through, wherein the buckle 843 can be located anywhere along the length of the crotch strap 825.

In accordance with one embodiment of the present invention, a method for facilitating the restraint of an individual within a vehicle using a vehicle restraint system is disclosed. The method can comprise providing a restraint framework having a plurality of supports, at least some of the supports comprising a restraint coupling location. The method can further comprise facilitating the releasable coupling of the supports to the vehicle. Additionally, the method can comprise facilitating the coupling of a passenger restraint to the restraint framework about the restraint coupling locations, the passenger restraint being configured to releasably restrain an individual about the restraint framework and the vehicle.

In one aspect, the method can further comprise providing a passenger restraint coupled to the restraint framework about the restraint coupling locations, the passenger restraint being configured to releasably restrain an individual about the restraint framework and the vehicle. In another aspect, the method can further comprise facilitating the length adjustment of at least one of the supports and an associated restraint coupling location. Facilitating the releasable coupling of the supports to the vehicle can comprise facilitating operation of a vehicle coupler with at least one of the supports, such as attaching a vehicle coupler to an end of the support. In one aspect, facilitating the coupling of a passenger restraint to the restraint framework can comprise securing a passenger restraint to the restraint framework. In another aspect, facilitating the coupling of a passenger restraint to the restraint framework can comprise providing a passenger restraint that removably couples to the restraint framework.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A restraint framework for supporting a passenger restraint and for facilitating restraint of a passenger within a vehicle, the restraint framework comprising:
a lateral support;
at least one upright support having a restraint coupling location that facilitates coupling of at least part of a passenger restraint to the upright support;
a plurality of vehicle couplers operable to facilitate securing of the upright and lateral supports to the vehicle at a plurality of vehicle attachment points;
a junction operable with the lateral support to secure the lateral support to the vehicle about a lower vehicle attachment point, wherein at least one of the lateral support and the junction includes a restraint coupling location that facilitates coupling with at least part of the passenger restraint; and
a plurality of adjustment members, at least one being operable with each of the upright and lateral supports to facilitate independent length adjustment, and to facilitate adjustment of the restraint coupling locations relative to the vehicle attachment points.

2. The restraint framework of claim 1, wherein the framework facilitates the releasable restraint of an individual about the upright and lateral supports.

3. The restraint framework of claim 1, wherein no part of the framework is used to directly releasably restrain an individual.

4. The restraint framework of claim 1, wherein each of the upright and lateral supports comprise an inseparable structural member.

5. The restraint framework of claim 1, further comprising a first upright support operable with a first lower vehicle coupler and a second upright support operable with a different lower vehicle coupler, wherein the first and second upright supports converge to a common location, and are operable with an upper vehicle coupler.

6. The restraint framework of claim 5, wherein at least one of the first upright support and the second upright support includes a restraint coupling location.

7. The restraint framework of claim 5, further comprising an upper extension operable with the first and second upright supports to secure the upright supports to the vehicle about an upper vehicle attachment point, wherein the upper extension comprises at least a portion of the first upright support and the second upright support as overlapped upon one another.

8. The restraint framework of claim 1, further comprising an upper extension operable with the at least one upright support to secure the upright support to the vehicle about an upper vehicle attachment point.

9. The restraint framework of claim 8, wherein the upper extension and the at least one upright support comprise separate structural members.

10. The restraint framework of claim 1, wherein the junction comprises a sewn joint.

11. The restraint framework of claim 1, wherein the junction comprises a plate having a lateral support coupling feature coupled to the lateral support, an upright support coupling feature coupled to the at least one upright support, and a restraint coupling location feature.

12. The restraint framework of claim 11, wherein at least one of the lateral support coupling feature and the restraint coupling location feature of the plate are configured at an angle relative to the at least one upright support of between about 0 degrees and about 45 degrees.

13. A passenger restraint system, comprising:
a restraint framework that removably couples to a vehicle, comprising at least one upright support, and a lateral support extending laterally relative to the upright supports, the upright and lateral supports being length adjustable to position restraint coupling locations about the upright and lateral supports that are adjustable relative to vehicle attachment points of the framework; and
a passenger restraint coupled to the restraint framework at the passenger restraint coupling locations, the passenger restraint being configured to releasably restrain an individual about the restraint framework and the vehicle.

14. The restraint framework of claim 13, wherein the restraint framework couples to the vehicle at three attachment points.

15. The restraint framework of claim 13, further comprising a plurality of vehicle couplers operable to facilitate coupling of the restraint framework to the vehicle at the vehicle attachment points.

16. The restraint framework of claim 13, wherein the passenger restraint is permanently coupled to the restraint framework.

17. The restraint framework of claim 13, wherein the passenger restraint is removably coupled to the restraint framework.

18. The restraint framework of claim 13, wherein the passenger restraint comprises a five point harness having first and second shoulder straps and a crotch strap.

19. The restraint framework of claim 13, wherein the passenger restraint comprises a three point buckle.

20. The restraint framework of claim 19, wherein the three point buckle includes a length adjustment feature for at least one strap operable with the buckle.

21. The restraint framework of claim 19, wherein the passenger restraint further comprises a crotch strap operable with a T-shaped buckle, and wherein the crotch strap is coupled to the lateral support via the T-shaped buckle.

22. The restraint framework of claim 13, wherein restraint framework comprises a junction operable with the lateral support to secure the lateral support to the vehicle about a lower vehicle attachment point.

23. The restraint framework of claim 22, wherein the junction comprises a sewn joint.

24. The restraint framework of claim 22, wherein the junction comprises a plate having a lateral support coupling feature coupled to the lateral support, an upright support coupling feature coupled to the at least one upright support, and a restraint coupling location feature coupled to the restraint.

25. A method for facilitating the restraint of an individual within a vehicle using a vehicle restraint system, the method comprising:
providing a restraint framework having a plurality of supports, at least some of the supports comprising a restraint coupling location;
facilitating the releasable coupling of the supports to the vehicle; and
facilitating the coupling of a passenger restraint to the restraint framework about the restraint coupling locations, the passenger restraint being configured to releasably restrain an individual about the restraint framework and the vehicle.

26. The method of claim 25, further comprising providing a passenger restraint coupled to the restraint framework about the restraint coupling locations, the passenger restraint being configured to releasably restrain an individual about the restraint framework and the vehicle.

27. The method of claim 25, further comprising facilitating the length adjustment of at least one of the supports to adjust a position of an associated restraint coupling location.

28. The method of claim 25, wherein facilitating the releasable coupling of the supports to the vehicle comprises facilitating operation of a vehicle coupler with at least one of the supports.

29. The method of claim 25, wherein facilitating the coupling of a passenger restraint to the restraint framework comprises securing a passenger restraint to the restraint framework.

30. The method of claim 25, wherein facilitating the coupling of a passenger restraint to the restraint framework comprises providing a passenger restraint that removably couples to the restraint framework.
